(19) United States
(12) Patent Application Publication
(10) Pub. No.: US 2003/0041048 A1
(43) Pub. Date: Feb. 27, 2003

(54) System and method for providing dymanic selection of communication actions using stored rule set

(76) Inventor: Senaka Balasuriya, Westmont, IL (US)

Correspondence Address: MOTOROLA INC, 600 NORTH US HIGHWAY 45, LIBERTYVILLE, IL, 60048-5343, US

(21) Appl. No.: 09/930,070

(22) Filed: Aug. 15, 2001

(51) Int. Cl. G06F 7/00

(52) U.S. Cl. 707/1

(57) ABSTRACT

A method and system is provided for selecting and executing an action in a communication node, wherein the communication node has access to at least a schedule database and a rules database. The method includes receiving an incoming communication and determining a priority of the communication, the priority being based on one or more of a caller identity, a device identity and an input priority value. The status of the subscriber is determined based on preexisting subscriber location and status information stored in the schedule database. The rules database is accessed, the rules database having a preexisting rule set of the subscriber. Responsive to the preexisting rule set, an action is selected based on a comparison of the communication priority and the subscriber status. The action is executed by the system.

### FIELD OF THE INVENTION

The present invention relates generally to communication systems. In particular, the present invention provides a method and system for dynamically selecting actions and dynamically routing communications to the most appropriate communication device of a user.

### BACKGROUND OF THE INVENTION

Customer services, such as voice mail service is well known in standard and cellular telephone systems. With voice mail services, one user can leave an audio message for another user when the other user is not available for some reason (e.g., is currently talking on the telephone or is physically not present to answer the telephone). In one typical scenario, a cellular telephone user makes a cellular telephone call to a telephone subscriber of the public switched telephone network (PSTN). When the PSTN subscriber is currently on the telephone and has purchased the voice mail service option from the local telephone service company, the call is transferred to a voice mail system together with a voice mailbox identification of the PSTN subscriber (typically the PSTN subscriber's telephone number). Upon receiving the call, the voice mail system retrieves the PSTN subscriber's audio prompt message from memory and conveys the prompt message to the caller. In response to the prompt message, the caller transmits an audio message that is stored by the voice mail system in a memory location associated with the PSTN subscriber. When the PSTN subscriber is alerted or eventually decides to check his or her voice messages, the PSTN subscriber simply calls the voice mail system and instructs the voice mail system (usually via telephone keypad entries, but alternately using voice commands) to retrieve and play the stored message.

In another typical scenario, a PSTN subscriber makes a telephone call to a cellular telephone user. When the cellular telephone user is currently unable to answer the call and has purchased the voice mail service option from the cellular telephone service provider, the call and a voice mailbox identification of the cellular subscriber (typically the cellular subscriber's telephone number) are transferred within the cellular system infrastructure to a voice mail system coupled to the cellular system infrastructure. Upon receiving the call, the voice mail system retrieves the cellular subscriber's audio prompt message from memory and conveys the prompt message to the caller via the cellular infrastructure. In response to the prompt message, the caller transmits an audio message that is stored by the voice mail system in a memory location associated with the cellular subscriber. To check his or her voice mail messages, the cellular subscriber simply calls the voice mail system and instructs the voice mail system to retrieve and play the stored message. In the above-described ways, voice mail allows cellular and PSTN users to receive messages that they would otherwise not be able to receive. Thus, voice mail is a very powerful communication feature in today's fast-paced world.

Current voice mail (VM) systems allow limited customization of voice mail messages. For example, some current voice mail systems have the capability to play one message during office hours and a different message after office hours. This illustrates a basic time-based method to determine which of two messages to present to callers.

It would be advantageous to provide an improved system and method by which a caller may find and contact a subscriber and/or relevant communication device to provide improved services.

### BRIEF DESCRIPTION OF THE DRAWINGS

FIG. 1 is a block diagram illustrating of a communication system;

FIG. 2 is a diagram illustrating an initial routine for populating a database in the communication system;

FIG. 3 is a flow chart illustrating a method providing a call action;

FIG. 4 is a flow chart continued from FIG. 3; and

FIG. 5 is a block diagram of another communication system.

### DETAILED DESCRIPTION OF THE PRESENTLY PREFERRED EMBODIMENTS

A method and system selects and executes an action in a communication node. The communication node is advantageously in communication with at least a schedule database and a rules database. When an incoming communication directed to a subscriber is received, a communication priority is determined. The status of the subscriber is determined by accessing the rules database, the rules database having a rule set for the subscriber. An action is selected based on the rule set for the subscriber using the communication priority and the subscriber status.

The system can include a communication device determining server, element or function that includes the capability to determine which communication device would be most appropriate in regards to contacting the subscriber and may be adapted to contact the subscriber via the most appropriate communication device. For pagers, cellular phones and other sophisticated communication devices, including wireless telematic devices, in addition to providing a number of customizable messages to callers, additional actions can include the option of contacting the subscriber by alternate devices other than the selected single telephone connection. Additionally, a caller may indicate the priority of a call responsive to which the system can determine an action based on a predetermined set of rules.

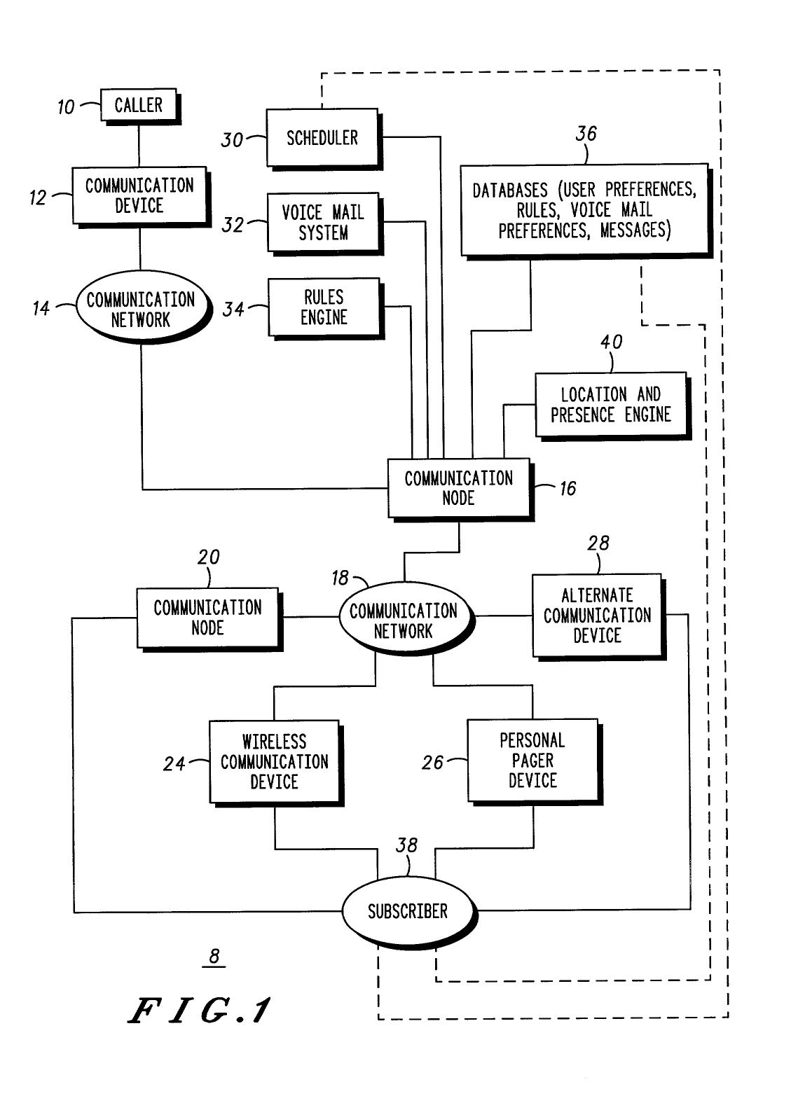

FIG. 1 illustrates generally the communication system 8 of the present invention. The communication system 8 generally includes a communication device 12 used by caller 10, communication networks 14, 18 and a communication node 16. The communication system 8 further includes a number of optional communication devices 20, 24, 26 and 28 to be used by subscriber 38.

To access and/or connect with the communication node 16, caller 10 may utilize the communication device 12 of the communication system 8. The communication devices 20, 24, 26 and 28 may be used by subscriber 38 to access and/or connect with communication node 16. The communication devices 12 and 20, 24, 26 and 28 can include, but are not limited to, wire-line telephones, mobile telephones, paging units, radio units, wireless data devices, Web telephones, portable or wireless telephones, personal information managers (PIMs), personal digital assistants (PDAs), personal computers (PCs), network televisions (TVs), Internet TVs, Internet telephones, portable wireless devices (i.e., two-way pagers), security systems (both mobile and premises-based), workstations, facsimile devices and printers or any other suitable communication devices.

The communication networks 14, 18 of the communication system 8 can include, but are not limited to, wire-line, wireless, GSM, TDMA, AMPS based systems, intranets, extranets, the Internet, a Local Area Network (LAN), a telephone network, (e.g., a Public Switched Telephone Network (PSTN), private telephone networks, and so on), a cellular network, satellite networks, a personal communication system, a TV network (e.g., a cable TV system), local, regional, national or global paging networks, an email system, a wireless data network (e.g., satellite data or local wireless data networks), a wireless LAN, a wireless local loop/distribution system (e.g., LMDS, MMDS or Code Division Multiple Access (CDMA) based system), a Voice Over Internet Protocol (VOIP) network, or any other suitable network. The communication networks 14, 18 can also include a wide area network (WAN), such as, for example, the Internet, the World Wide Web (WWW) or any other similar on-line service. It will be recognized that the communication networks 14,18 may have portions in common, may comprise two separate networks, or may be the same network.

Communication network 18 may connect to a number of communication devices used by subscriber 38 of the system; the devices are exemplified herein as communication device 20, wireless communication device 24, personal pager device 26 and alternate communication device 28. It should be understood that other communication devices might be included in the system in addition to those shown in the figure.

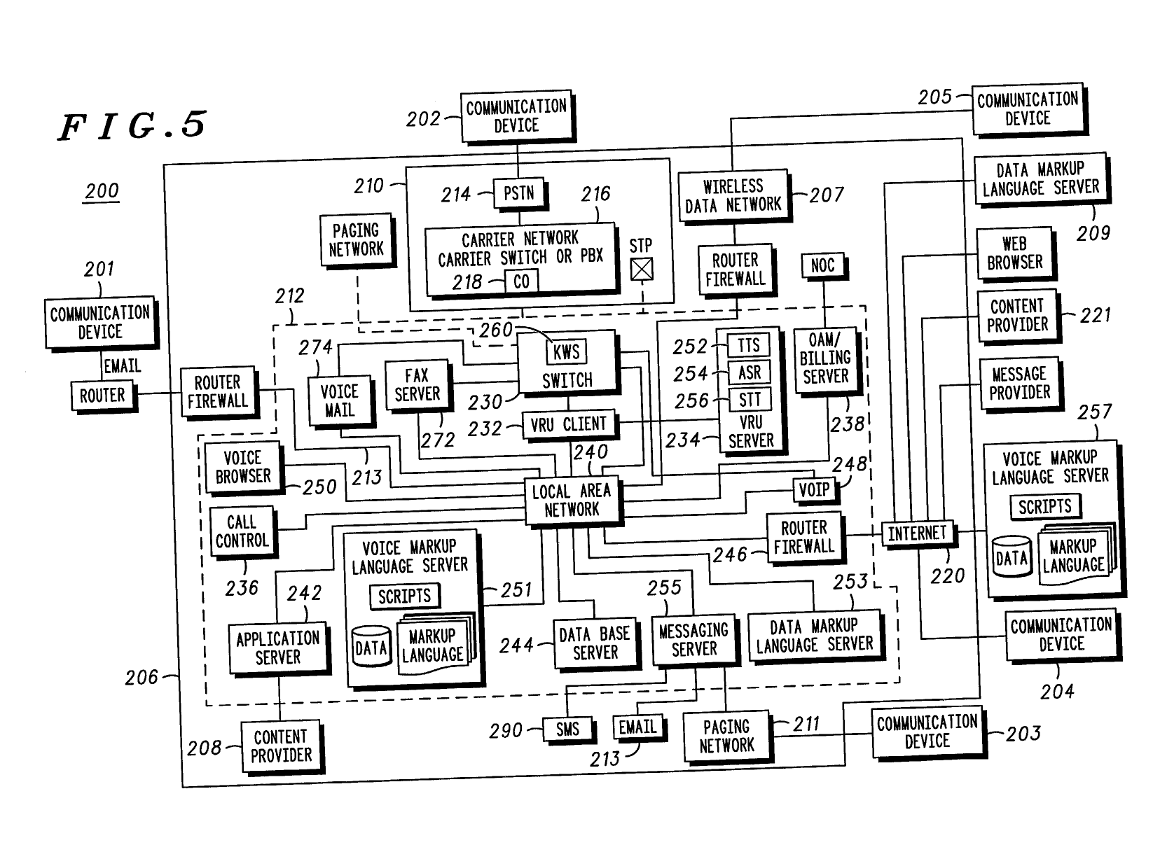

The communication node 16 of the communication system 8 can include, but is not limited to, an interactive voice response node, a server computer, the MIX™ platform and the Myosphere™ Service provided by Motorola, Inc. of Schaumburg, Ill. (as further described with reference to FIG. 5), or other suitable system. It will be recognized that the communication node 16 may be integrated within or may be remote from the communication networks 14, 18. Further, the communication node 16 may be integrated in a central system or may be a distributed system.

The communication devices 12, 20, 24, 26 and 28 communicate with communication networks 14, 18 via the communication node 16. The communication network 14, 18 can interface with the communication devices 12, 20, 24, 26 and 28 through wire-line or wireless networks or systems (i.e., telephone or televisions systems, Integrated Services Digital Network (ISDN) systems, coaxial lines, computer networks, digital end user lines, private networks, wireless local loop systems, etc.).

The communication node 16 may incorporate, or be associated with or in communication with an electronic calendar or scheduler 30, voice mail system 32, rules engine 34, databases 36 and a location and presence engine 40. The scheduler 30 may be an electronic scheduler application; such as that available in Microsoft® Outlook, or the like, which is accessible to the subscriber 38 and in communication with the communication node 16. Preferably, the subscriber 38 can assign priorities to each event scheduled in the scheduler 30. The voice mail system 32 is any voice mail system that is capable of being accessed by the communication node 16 and capable of recording messages and playing back a number of messages in response to a request from the communication node 16. The communication node 16 can access the rules engine 34. The communication node 16 can use the rules engine 34 to make determinations based on subscriber information stored in databases 36 and other criteria, such as the location of the subscriber and the time of call. The determinations can include call forwarding and voicemail playback. Databases 36 may be a single database or a multiple database system, housed in a single server, or the like, or located in multiple servers and locations. Databases 36 are accessible by the subscriber 38 and may include subscriber information stored as preferences, rules, voice mail preferences and voice mail messages and so on, as will be described more fully hereinafter. The location and presence engine 40 is a system or interface adapted to obtain location and presence information of the subscriber. The engine 40 is adapted to detect presence which is defined as whether the subject is busy, available, not available, offline and online and so on.

As further described below, the communication system 8 can provide various services and capabilities to cellular end users, wire-line telephone end users, paging end users, satellite end users, mobile or portable telephone end users, trunked end users, computer network end users (e.g., Internet or Intranet end users), wireless data end users, branch office end users and the like. In addition to recording voice messages and routing incoming communications, for example, by way of the voicemail system 32 and a routing and messaging system (not shown), the communication system 8 can provide speech and/or touch-tone recognition, incoming call authorization, call routing, text-to-speech (TTS) and/or speech-to-text (STT) capabilities, content information, messaging services, call screening, interactive voice applications, instant messaging and unified messaging services, and so on.

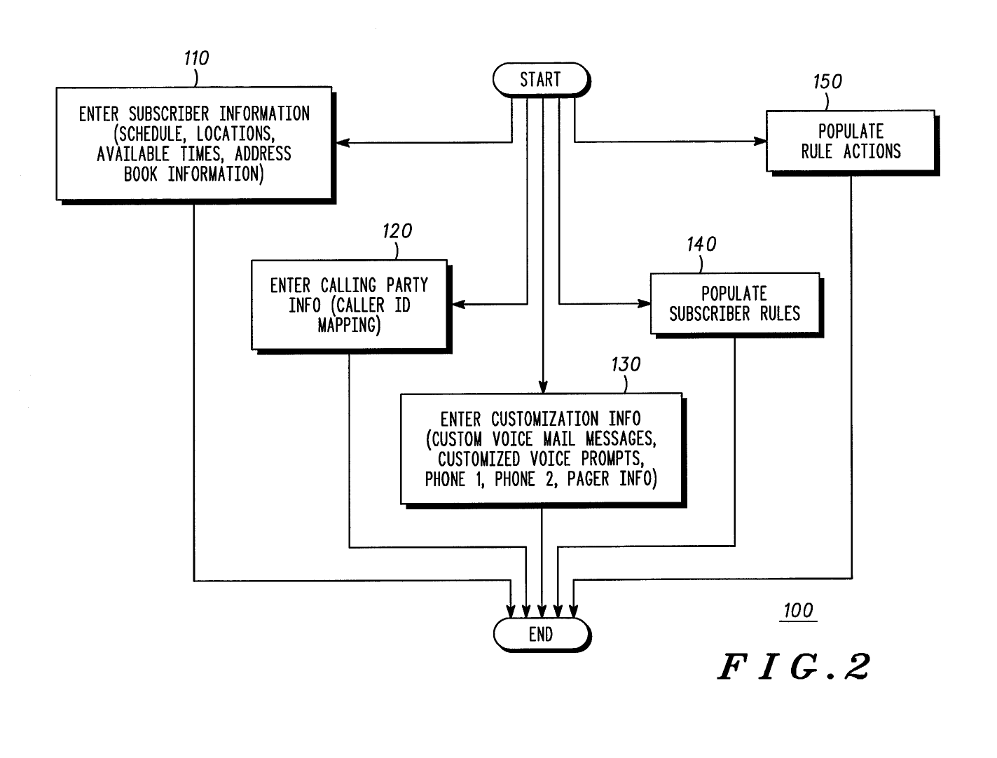

FIG. 2 illustrates one embodiment of an initial routine, generally referred to by reference character 100, for populating the databases 36 and setting the rules in accordance with the present invention. Before the system 8 is fully operational it is preferable to populate databases 36 depending on the options offered by a service provider or subscribed to by the subscriber 38. It will be understood that the order that the various databases are populated is not critical to the invention. Generally, the initial routine includes population of or provisioning of the various databases with information that the system uses to perform various determinations and select and execute various actions. The provisioning of the databases may be done directly by the subscriber, by an assistant or by members of the service provider or by synchronizing with other databases. Revisions or maintenance of the databases may occur in a similar fashion. In all probability, however, the subscriber would most efficiently perform maintenance of the scheduler database.

The databases included in the initial routine include a subscriber information database. With respect to block 110, the subscriber information database includes information such as schedule, location, available time, address book information and information pertaining to determining the location of the user. The subscriber information may include a priority associated with each entry in the schedule. Entries may include meetings, for example. Also, a priority can be assigned to each location or address in the supplied address book information. In this manner, a priority, relative to a subscriber location, is assignable for use by the system in making a determination as to what action should be taken in response to an incoming call.

With respect to block 120, the initial routine includes the entering of information related to each calling party, i.e., caller ID mapping. Caller ID mapping allows the system 8 to identify incoming callers according to caller ID. The caller ID may originate from caller line identification (CLI), caller device identification or a manual input of caller identification. The caller identity may be derived from a phone number, an IP address, network identification, or an e-mail address or a PIN number or the like. Identification by CLI is known in the art. Manual input may include methods such as the caller entering a personal identification number (PIN), with or without a prompt by the system and audibly projecting voice identification or the like. Other methods to identify the caller include voice authentication, identification of IP address and other device identification information.

With respect to block 130, the initial routine includes the entering of customization information. In this step, the subscriber 38 can enter a number of custom voice mail messages, personal voice messages, pager number and personal voice prompts and other information, such as contact information to be used by the voice mail system 32. The subscriber also may provide information relating to his or her alternate communication devices such as a pager number. The subscriber 38 or the service provider, or the like, may also provide information relating to finding the location or the subscriber presence information. For example, this may include configuring the information needed to access a location determination and presence engine. In the event that an initial call attempt is unsuccessful and the system determines that the subscriber should be contacted by alternate communication devices (as opposed to recording a message) the information relating to the alternate communication devices enables the system 8 to perform a further attempt to contact the subscriber.

With respect to block 140 and block 150, the initial routine includes the entering of subscriber rules (block 140) and subscriber rule actions (block 150). The subscriber rules are rules that instruct the system (in one embodiment, performed by a rules engine) as to how to proceed according to various variables defined in the rules database. The rule actions are the actions which the system performs responsive to the determinations made by the rules engine. The variables to be included in the rules database include the caller identity, caller priority, the subscriber location, time of call, subscriber status, and the action. An example of a rules table for a rules database is shown below in Table 1.

TABLE I

| | Call | | | Subscriber | |
|---|---|---|---|---|---|
| Caller | Priority | Subscriber | Time of | Busy Status | |
| Identity | of Caller | Location | Call | (Priority) | Action |
| <Default> or | <Any> | <Any> | <Any> | <Any> | Regular voicemail |
| Unknown | | | | | |
| 123.33.34.555 | <Any> | <Any> | 8am-5pm | <Any> | Regular Voicemail + Pager |
| (IP Address) | | | M-F | | Information |
| or 123-456- | | | | | |
| 7890 | | | | | |
| Telephone #) | | | | | |
| Spouse@spouses | Low | Office | 8am-5pm | At desk | Regular Voicemail + Option to |
| company.com | (Normal) | | M-F | (Low) | Page |
| Spouse@spouses | Medium | Office | 8am-5pm | At Desk | Regular Voicemail + Automatic |
| company.com | | | M-F | (Low) | Page to Subscriber |
| 123-456-7890 | Low, | <Any> | <Any> | Meeting | Customized Voicemail + Option |
| (Spouse's | Medium | | | (Medium) | to Page |
| Office) | | | | | |
| 123-456-7890 | High | Office | <Any> | <Any> | Customized Voicemail + |
| (Spouse's | | | | | Schedule Info + Automatic |
| Office) | | | | | Page to Subscriber |
| 123-456-7890 | High | Not in | <Any> | <Any> | Customized Voicemail (e.g., |
| (Spouse's | | Office | | | “Not in Office”) + |
| Office) | | | | | Contact/Location Info + |
| | | | | | Automatic Page to Subscriber |

Referring to Table 1, the rules database 36 may include a caller identity, a call priority (that may be a caller priority or a call device priority) a subscriber location, a time of call, a subscriber status (priority) and an action portion. As discussed above, the caller identity may be determined by CLI, caller device identification or an input code by keypad, voice or other known methods.

The call priority may be determined through the caller identity or may be input manually by the caller 10 before or after a prompt from the system 8. The caller 10 may input the priority by keypad, voice or other methods. The subscriber location is determined by the system 8 accessing the electronic scheduler 30 with location information or a location and presence determination system, or the like, of the subscriber. The time of call is derived from the time the call is received by the system.

The subscriber status (priority) may be determined by the system 8 obtaining the status from the subscriber scheduler 30, address book 36, location and presence engine 40, a combination thereof and the like. In the alternate, the status/priority may be changed or overridden by the subscriber 38 when, for example, the subscriber, contrary to the entry in the scheduler, unexpectedly becomes busy or unoccupied. In this manner the subscriber can provide feedback to the process, in that, the subscriber 38 may perform a change of status in real time by either electing to receive a communication directed to the subscriber 38 by the system 8 or directing the system to direct the call to a voicemail 32 option or any one of several options. The options can include directing the system to execute a second action based on the feedback or a number of sequential actions including call forwarding, first and second call actions, sending a message and so on.

The action fields may include a number of options. For example, a regular and a number of customized voicemails may be specified. The rules table in the database 36 may specify pager and wireless telephone information. The rules may specify a number of other options including automatic page options, forwarding of the call to an administrative assistant, forwarding of the call to an alternate phone device, forwarding of the call to a wireless information device and/or the provision of contact/location information, and forwarding of the call to a personal assistant that may transcribe the message and can dispatch it in a different format such as an instant message. The portion of the system adapted to determine the location of the subscriber is also adapted to verify the location of the subscriber by known methods.

It can be seen in the examples given in Table 1 that a caller 10 with an unknown identity will be presented with a regular voicemail regardless of a priority of the call, the time of call, the subscriber location and so on. If a caller 10 identity is established, but does not match any of the stored caller identities, the caller can be presented with a regular voicemail and pager information regardless of the given priority, the subscriber location, and the subscriber status if the time of the call is during working hours. If the call arrives outside of the 8am-5pm work hours, for example, the system 8 can be configured to merely present a regular voicemail or other options.

As can be seen in further examples, generally, it may be advantageous to configure the system 8 to provide more action options as the priority of the call becomes relatively high compared to that of the subscriber 38. For example, if a spouse places a call having a low priority, and the subscriber 38 is at an office location with a low priority, the system 8 can present a regular voicemail message with an option to page. If the spouse's caller priority is a medium priority, the system 8 can present a regular voicemail and automatically pages the subscriber. If the spouse's caller priority is high, the system 8 presents a customized voicemail, schedule information, and executes an automatic page to the subscriber 38.

Table 1 illustrates a number of optional scenarios and outcomes dependent upon the particular variables in a call event. Other scenarios are possible dependent upon the complexity of the rules and the possible actions to be taken. Accordingly, it will be understood that the table presented is illustrative in nature and not restrictive.

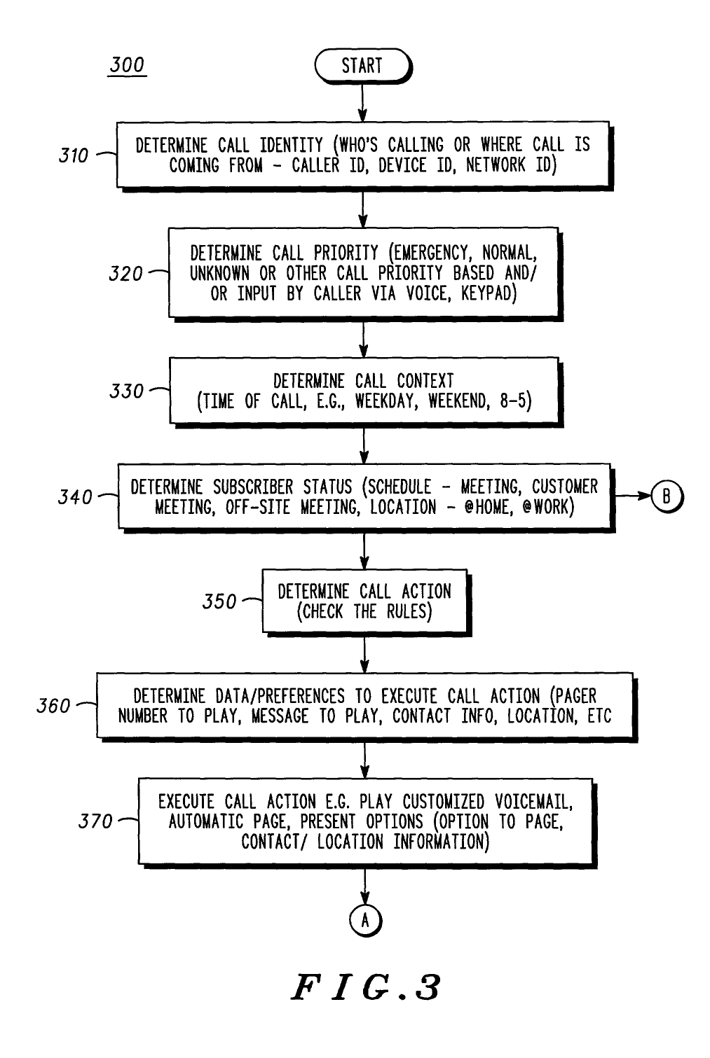

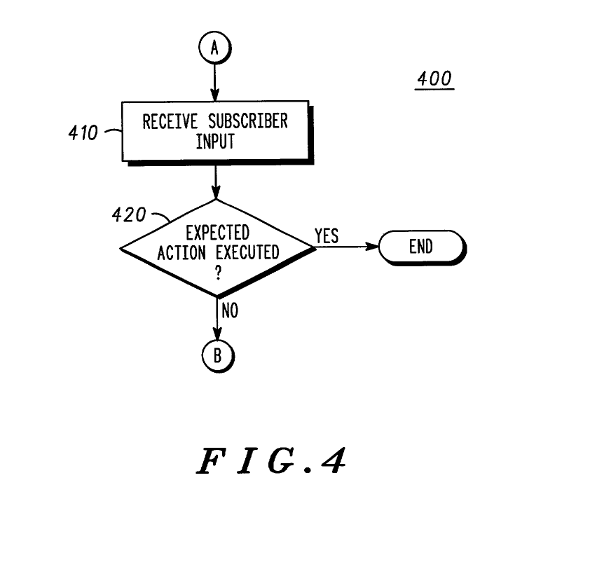

FIGS. 3 and 4 are presented to illustrate the method of the present invention generally referred to as reference characters 300 and 400, respectively. It should be understood that the order of many of the steps as presented herein could be changed without affecting the functioning of the system 8 or the outcome. As such, the method presented herein should be considered exemplary in nature.

In block 310, the caller identity is determined. The caller identity may identify the person calling by determining the CLI or caller device identity or an alternate method such as voice identification, inputting of a PIN number or the like. In block 320, the call context/priority is determined. Examples of a call priority may include low, medium, normal, high and emergency. The call priority can be determined by the system accessing the rules database where a priority may be associated with each preexisting caller identity. The caller using a keypad, by voice or other manual data input, may set the call priority manually. In one example, a subscriber's supervisor can be assigned a high priority in the system so that calls from the supervisor are always given a high priority. In an emergency, a spouse may enter a high priority to evoke an action from the system that locates and contacts the subscriber instead of merely playing a voicemail response and offering to record a voice message.

In block 330, the time of call is determined. The time of call can be used by the system when accessing the location database to determine the location of the subscriber. The time of call can be used to check the subscriber schedule, rules pertaining to specific times, days, weekends, night and so on. The time can be used to provide time and time zone based services. In block 340, the subscriber status (priority) is determined. The system uses the schedule, presence and location information, each with an associated priority to determine the subscriber or subscriber status. The status may include schedule information such as the subscriber being in a meeting—which may have priorities from low to high. If the subscriber is in a customer meeting the priority may be medium or high since typically one might not wish to be disturbed during a meeting with an important client or customer. The schedule might include location information detailing the location of an off-site meeting with associated contact information including an address and off-site phone numbers. The location can include the subscriber being at home or at work, for example.

In block 350, the system determines an initial data set using any of the determined caller ID, call context, call time and subscriber status. The initial data thus determined is compared to the rules via a rules engine and an action or action set is selected. The system can include paging and various message options at this point. The system, as shown in block 360, determines or obtains the subscriber preferences to select the call action. The subscriber preferences may include which of a pager number to use, a message to play, contact information, location information and alternate contact numbers or methods. Also, the system can perform paging and various message options.

In block 370, the action selected in block 360 is executed. The actions include the playing of a regular or customized voicemail message, execution of an automatic page or data communication (by wire phone, wireless phone, e-mail and so on), paging, instant messages, small message system (SMS) options and a presentation of other options. The other options include an option to page and the presentation of contact and/or location information. At block 410, the subscriber is given further options by the system. The subscriber may elect to receive the message via pager or wireless phone, for example, may select to direct the call to voice mail or offer other options. Essentially, in this manner the subscriber may interactively direct the system to one or more option. This interactive aspect of the invention allows the subscriber to direct the system in response to a changing situation.

At block 420, the system determines if the selected action has been successfully implemented. If the selected action has been successfully been implemented and carried out, the process terminates. If the action is unsuccessful, the system (at B) loops back to block 340, updates the subscriber status and continues sequentially through the steps to completion. For example, based on subscriber feedback, the system determines that the expected action has not been executed successfully and may seek an alternate action (including further refinement of rules based on subscriber feedback).

Referring now to FIG. 5, an exemplary block diagram of another embodiment of a communication system 200 having the capability to select and execute an action based on a rules database as set forth in the above description is illustrated. The communication system 200 generally includes one or more communication devices 201, 202, 203, 204, 205 (five being shown), an electronic network 206, and one or more information sources (e.g., content providers 208, 221 (two being shown) and data and voice markup language servers 209, 251, 253, 257).

The user (a caller or a subscriber) can access the electronic network 206 by dialing a single direct access telephone number (e.g., a foreign telephone number, a local telephone number, or a toll-free telephone number or PBX) from the communication device 202. The user can also access the electronic network 206 from the communication device 204 via the Internet 220 or WWW, from the communication device 203 via a paging network 211, or from the communication device 205 via a LAN, a WAN, an e-mail connection or in any other similar manner.

As shown in FIG. 5, the electronic network 206 includes a telecommunication network 210 and a communication node 212. The telecommunication network 210 is preferably connected to the communication node 212 via a high-speed data link, such as, for example, a T1 telephone line, a LAN, a WAN or a VOIP network. The telecommunication network 210 preferably includes a PSTN 214 and a carrier network 216. The telecommunication network 210 can also include, for example, international or local exchange networks, cable TV networks, inter-exchange carrier or long distance carrier networks, cellular networks (e.g., mobile switching centers), PBXs, satellite systems, wireless data networks and other switching centers such as conventional or trunked radio systems (not shown), and so on. The electronic network 206 can also include additional telecommunication networks, such as, for example, a wireless data network 207.

The PSTN 214 can include various types of communication equipment, such as, for example, ATM networks, Fiber Distributed Data networks (FDDI), T1 lines, cable TV networks, VOIP networks and the like. The carrier network 216 generally includes a telephone switching system or CO 218. It will be recognized that the carrier network 216 can be any suitable system that can route calls to the communication node 212, and the CO 218 can be any suitable wire-line or wireless switching system.

The communication node 212 is preferably configured to receive and process incoming calls from the carrier network 216 and the Internet 220. The communication node 212 can receive and process pages from the paging network 211 and can also receive and process messages (e.g., e-mails) from the LAN, WAN, wireless data or e-mail system 213.

When a user dials into the electronic network 206 from the communication device 202, the carrier network 216 routes the incoming call from the PSTN 214 to the communication node 212 over one or more telephone lines or trunks. The incoming calls may enter the carrier network 216 through one or more “888” or “800” Inward Wide Area Telecommunications Services trunk lines, local exchange or long distance trunk lines. It is also contemplated that the incoming calls can be received from a cable, cellular or VOIP network or any other suitable system.

The communication node 212 answers the incoming call from the carrier network 216 and may retrieve an appropriate announcement (e.g., a welcome greeting) from a database, server or browser. The communication node 212 then plays the announcement to the caller. In response to audio inputs from the user, the communication node 212 retrieves information from a destination or database of one or more of the information sources, such as the content providers 208, 221 or the markup language servers 209, 251, 253, 257. After the communication node 212 receives the information, it provides a response to the user based upon the retrieved information.

The communication node 212 can provide various dialog voice personalities (e.g., a female voice, a male voice, etc.), and can implement various grammars (e.g., vocabulary) to detect and respond to the audio inputs from the user. In addition, the communication node 212 can automatically select various speech recognition models (e.g., English, Spanish or English accent models) based upon a user's profile, communication device and/or speech patterns. The communication node 212 can also allow the user to select a particular speech recognition model.

When a user accesses the electronic network 206 from a communication device 201, 202, 203, 204, 205 registered with the system (e.g., home telephone, work telephone, cellular telephone, etc.), the communication node 212 can by-pass a user screening option and automatically identify the user (or the type of communication device) through the use of ANI or CLI. After the communication node 212 verifies the call, the communication node 212 provides a greeting (e.g., “Hi, this is your personal agent, Mya. Welcome Bob. How may I help you?”). The communication node 212 then enters into a dialogue with the user, and the user can select a variety of services offered by the communication node 212.

When the user accesses the electronic network 206 from a communication device not registered with the system (e.g., a payphone, a telephone of a non-user, etc.), the communication node 212 answers the call and can prompt the user to enter his or her name and/or a personal identification number (PIN) using voice commands or DTMF signals. The communication node 212 can also utilize speaker verification to identify the particular speech pattern of the user. If the communication node 212 authorizes the user to access the system, the communication node 212 provides a personal greeting to the user (e.g., “Hi, this is your personal agent, Mya. Welcome Ann. How may I help you?”). The communication node 212 then enters into a dialogue with the user, and the user can select various services offered by the communication node 212. If the name and/or PIN of the user cannot be recognized or verified by the communication node 212, the user will be routed to a customer service representative.

Once the user has accessed the communication system 200, the user may implement a wide variety of services and features by using voice commands, such as, for example, voice dialing, voice paging, facsimiles, caller announcements, voice mails, reminders, call forwarding, call recording, content information (e.g., newspapers, etc.), read e-mail, read calendars, read “to-do” lists, banking, e-commerce. The communication system 200 can place outbound calls and pages to business and personal parties or contacts (e.g., friends, clients, business associates, family members, etc.) in response to DTMF signals or voice commands. The calls can be routed through a telephone or electronic network to the selected party and the pagers can be sent to a selected party via a paging system. The communication system 200 can also receive calls routed through a telephone or electronic network.

As shown in FIG. 5, the communication node 212 preferably includes a telephone switch 230, a voice or audio recognition (VRU) client 232, a VRU server 234, a controller or call control unit 236, an Operation and Maintenance Office or a billing server unit 238, a LAN 240, an application server unit 242, a database server unit 244, a gateway server or router firewall server unit 246, a VOIP unit 248, a voice browser 250, a voice markup language server 251, a messaging server 255 and a data markup language server 253. Although the communication node 212 is shown as being constructed with various types of independent and separate units or devices, the communication node 212 can be implemented by one or more integrated circuits, microprocessors, microcontrollers or computers which may be programmed to execute the operations or functions equivalent to those performed by the devices or units shown. It will also be recognized that the communication node 212 can be carried out in the form of hardware components and circuit designs and/or software or computer programs.

The communication node 212 can be located in various geographic locations throughout the world or the United States (e.g., Chicago, Ill.). The communication node 212 can be operated by one or more carriers (e.g., Sprint, Qwest, MCI, etc.) or independent service providers (e.g., Motorola, Inc.).

The communication node 212 can be integrated with the carrier network 216 or can be located remote from the carrier network 216. It is also contemplated that the communication node 212 may be integrated into a communication device, such as, for example, a wire-line or wireless telephone, a radio device, a PC, a PDA, a PIM, etc., and can be programmed to connect or link directly to an information source.

The communication node 212 can also be configured as a standalone system to allow users to dial directly into the communication node 212 via a direct access telephone number. In addition, the communication node 212 may comprise a telephony switch (e.g., a PBX or Centrix unit), an enterprise network or a LAN. In this configuration, the communication system 200 can be implemented to automatically connect a user to the communication node 212 when the user accesses a communication device.

When the telephone switch 230 receives an incoming call from the carrier network 216, the call control unit 236 sets up a connection in the telephone switch 230 to the VRU client 232. The communication node 212 can then enter into a dialog with the user regarding various services and functions. The VRU client 232 preferably generates pre-recorded voice announcements and/or messages to prompt the user to provide inputs to the communication node 212 using voice commands or DTMF signals. In response to the inputs from the user, the communication node 212 retrieves information from a destination of one of the information sources and provides outputs to the user and can also route incoming calls to any one of the various outgoing communication options.

The telephone switch 230 is preferably connected to the VRU client 232, the VOIP unit 248 and the LAN 240. The telephone switch 230 receives incoming calls from the carrier network 216. The telephone switch 230 also receives incoming calls from the communication device 202 routed over the Internet 220 via the VOIP unit 248. The telephone switch 230 also receives messages and pages from communication devices 203, 205, respectively. The telephone switch 230 is preferably a digital cross-connect switch, Model LNX, available from Excel Switching Corporation, Hyannis, Mass. It will be recognized that the telephone switch 230 can be any suitable switch.

The VRU client 232 is preferably connected to the VRU server 234 and the LAN 240. The VRU client 232 processes voice communications, DTMF signals, pages and messages (e.g., e-mails). Upon receiving voice communications, the VRU client 232 routes the speech communications to the VRU server 234. When the VRU client 232 detects DTMF signals, it sends a command to the call control unit 236. It will be recognized that the VRU client 232 can be integrated with the VRU server 234.

The VRU client 232 preferably comprises a PC, such as, for example, a Windows NT compatible PC, with hardware capable of connecting individual telephone lines directly to the telephone switch 230 or carrier network 216. The VRU client 232 preferably includes a microprocessor, random access memory, read-only memory, a T1 or ISDN interface board, and one or more voice communication processing boards (not shown). The voice communication processing boards are preferably Dialogic boards, Antares Model, available from Dialogic Corporation, Parsippany, N.J. The voice communication boards may include a voice recognition engine having a vocabulary for detecting a speech pattern. The voice recognition engine is preferably a RecServer software package, available from Nuance Communications, Menlo Park, Calif.

The VRU client 232 can also include an echo canceler (not shown) to reduce or cancel TTS or playback echoes transmitted from the PSTN 214 due to hybrid impedance mismatches. The echo canceler is preferably included in an Antares Board Support Package, also available from Dialogic.

The call control unit 236 is preferably connected to the LAN 240, and sets up the telephone switch 230 to connect incoming calls to the VRU client 232. The call control unit 236 also sets up incoming calls or pages to the communication node 212 over the Internet 220 and pages and messages sent from the communication devices 203, 205 via the paging network 211 and e-mail system 213, respectively. The control call unit 236 preferably comprises a PC, such as, for example, a Windows NT compatible PC.

The LAN 240 allows the various components and devices of the communication node 212 to communicate with each other via twisted pair, fiber optic, coaxial cables or the like. The LAN 240 may use Ethernet, Token Ring or other suitable types of protocols. The LAN 240 is preferably a 100 Megabit per second Ethernet switch, available from Cisco Systems, San Jose, Calif., and can comprise any suitable network system. The communication node 212 may include a plurality of LANs.

The VRU server 234 is connected to the VRU client 232 and the LAN 240. The VRU server 234 receives voice communications from the user via the VRU client 232. The VRU server 234 processes the voice communications and compares the voice communications against a vocabulary or grammar stored in the database server unit 244 or a similar memory device. The VRU server 234 provides output signals, representing the result of the voice communications processing, to the LAN 240. The LAN 240 routes the output signal to the call control unit 236, the application server unit 242 and/or the voice browser 250. The communication node 212 then performs a specific function associated with the output signals.

The VRU server 234 preferably includes a TTS unit 252, an automatic speech recognition (ASR) unit 254, and a STT unit 256. The TTS unit 252 receives textual data or information (e.g., e-mail, web pages, documents, files, etc.) from the application server unit 242, the database server unit 244, the call control unit 236, the gateway server unit 246, the application server unit 242 and the voice browser 250. The TTS unit 252 processes the textual data and converts the data to voice data or information.

The TTS unit 252 can provide data to the VRU client 232, which reads or plays the data to the user. For example, when the user requests information (e.g., news updates, stock information, traffic conditions, etc.), the communication node 212 retrieves the desired data (e.g., textual information) from a destination of the one or more of the information sources and converts the data via the TTS unit 252 into a response.

The response is then sent to the VRU client 232. The VRU client 232 processes the response and reads an audio message to the user based upon the response. It is contemplated that the VRU server 234 can read the audio message to the user using human recorded speech or synthesized speech. The TTS unit 252 is preferably a TTS 2000 software package, available from Lernout and Hauspie Speech Product NV, Burlington, Mass.

The ASR unit 254 provides speaker dependent or independent automatic voice recognition of voice communications from the user. It is contemplated that the ASR unit 254 can include speaker dependent voice recognition. The ASR unit 254 processes the voice communications to determine whether a word or a speech pattern matches any of the grammars or vocabulary stored in the database server unit 244 or downloaded from the voice browser 250. When the ASR unit 254 identifies a selected speech pattern of the voice communications, the ASR unit 254 sends an output signal to implement the specific function associated with the recognized speech pattern. The ASR unit 254 is preferably a speaker independent voice recognition software package, RecServer Model, also available from Nuance Communications. It is contemplated that the ASR unit 254 can be any suitable voice recognition unit to detect voice communications.

The STT unit 256 receives voice communications and converts the voice communications to textual information (e.g., a text message). The textual information can be sent or routed to the communication devices 201, 202, 203, 204, 205, the content providers 208, 221, the markup language servers 209, 251, 253, 257, the voice browser 250 and the application server unit 242. The STT unit 256 is preferably a Naturally Speaking software package, available from Dragon Systems, Newton, Mass.

The VOIP unit 248 is preferably connected to the telephone switch 230 and the LAN 240. The VOIP unit 248 allows a user to access the communication node 212 via the Internet 220 or VOIP public network using voice commands. The VOIP unit 248 can receive VOIP protocols (e.g., H.323 protocols) transmitted over the Internet 220 or Intranet, and can convert the VOIP protocols to voice information or data. The voice information can then be read to the user via the VRU client 232. The VOIP unit 248 can also receive voice communications from the user and convert the voice communications to a VOIP protocol that can be transmitted over the Internet 220. The VOIP unit 248 is preferably a Voice Net software package, also available from Dialogic Corporation. It will be recognized that the VOIP unit 248 can be incorporated into a communication device.

The communication node 212 also includes a detection unit 260. The detection unit 260 is preferably a phrase or key word spotter unit, detecting incoming audio inputs or communications or DTMF signals from the user. The detection unit 260 is preferably incorporated into the telephone switch 230, but can be incorporated into the VRU client 232, the carrier network 216 or the VRU server 234. The detection unit 260 is preferably included in a RecServer software package, also available from Nuance Communications.

The detection unit 260 records the audio inputs from the user and compares the audio inputs to the vocabulary or grammar stored in the database server unit 244. The detection unit 260 continuously monitors the user's audio inputs for a key phase or word after the user is connected to the node 212. When the detection unit 260 detects the key phrase or word, the VRU client 232 plays a pre-recorded message to the user. The VRU client 232 then responds to the audio inputs provided by the user.

The billing server unit 238 is preferably connected to the LAN 240. The billing server unit 238 can record data about the use of the communication node 212 by a user (e.g., length of calls, features accessed by the user, etc.). Upon completion of a call by a user, the call control unit 236 sends data to the billing server unit 238. The billing server unit 238 can subsequently process the data in order to prepare customer bills. The billing server unit 238 can use the ANI or CLI of the communication device to properly bill the user. The billing server unit 238 preferably comprises a Windows NT compatible PC.

The gateway server unit 246 is preferably connected to the LAN 240 and the Internet 220. The gateway server unit 246 provides access to the content provider 221 and the voice markup language server 257 via the Internet 220. The gateway server unit 246 allows users to access the communication node 212 from the communication device 202 via the Internet 220. The gateway server unit 246 can function as a firewall to control access to the communication node 212 to authorized users. The gateway server unit 246 is preferably a Cisco Router, also available from Cisco Systems.

The database server unit 244 is preferably connected to the LAN 240. The database server unit 244 preferably includes a plurality of storage areas to store data relating to users, such as, for example, speech vocabularies, dialogs, personalities, user entered data, and other information as discussed above. Preferably, the database server unit 244 stores a personal file or address book. The personal address book can contain information required for the operation of the communication system 200, including user reference numbers, personal access codes, personal account information, contact's addresses, telephone numbers, etc. The database server unit 244 is preferably a PC, such as, for example, a Windows NT compatible PC.

The application server unit 242 is preferably connected to the LAN 240 and the content provider 208. The application server unit 242 allows the communication node 212 to access information from a destination of the information sources, such as the content providers 208, 221 and the markup language servers 209, 251, 253, 257. For example, the application server unit 242 can retrieve information (e.g., weather reports, stock information, traffic reports, restaurants, flower shops, banks, calendars, “to-do” lists, e-commerce, etc.) from a destination of the information sources. This application server unit 242 may include Starfish Software to provide the address book, calendar and to-do lists, and to allow the user to organize information. The application server unit 242 processes the retrieved information and provides the information to the VRU server 234 and the voice browser 250. The VRU server 234 can provide an audio announcement to the user based upon the information using TTS synthesizing or human recorded voice. The application server unit 242 can also send tasks or requests (e.g., transactional information) received from the user to the information sources (e.g., a request to place an order for a pizza). The application server unit 242 can further receive user inputs from the VRU server 234 based upon a speech recognition output. The application server unit 242 is preferably a PC.

The voice markup language server 251 is preferably connected to the LAN 240. The voice markup language server 251 can include a database, scripts and markup language documents or pages. The voice markup language server 251 is preferably a PC, such as, for example, a Windows NT compatible PC. It will also be recognized that the voice markup language server 251 can be an Internet server (e.g., a Sun Microsystems server).

The messaging server 255 is preferably connected to the LAN 240, the paging network 211, an e-mail system 213 and a short message system (SMS) 290. The messaging server 255 routes pages between the LAN 240 and the paging network 211. The messaging server 255 is preferably a PC, such as, for example, a Windows NT compatible PC. The messaging server 255 can also provide direct storage. It is contemplated that the messaging server 255 can reside externally from the communication node 212.

The voice browser 250 is preferably connected to the LAN 240. The voice browser 250 preferably receives information from the markup language servers 209, 251, 253, 257, the database server unit 244 and the content providers 208, 221. In response to voice commands or DTMF signals, the voice browser 250 generates a content request (e.g., an electronic address) to navigate to a destination of one or more of the information sources. The content request can use at least a portion of a Uniform Resource Locator, an Internet Protocol, a page request, or e-mail.

After the voice browser 250 is connected to an information source, the voice browser 250 preferably uses a Transmission Control Protocol/Internet Protocol connection to pass requests to the information source. The information source responds to the requests, sending at least a portion of the requested information, represented in electronic form, to the voice browser 250. The information can be stored in a database, and can include text content, markup language document or pages, non-text content, dialogs, audio sample data, recognition grammars, etc. The voice browser 250 then parses and interprets the information, further described below. The voice browser 250 can be integrated into the communication devices 201, 202, 203, 204, 205.

As shown in FIG. 5, the content provider 208 is connected to the application server unit 242 of the communication node 212, and the content provider 221 is connected to the gateway server unit 246 of the communication node 212 via the Internet 220. The content providers 208, 221 can store various content information, such as news, banking, commerce, weather, traffic conditions, etc. The content providers 208, 221 can include a server to operate WWW pages or documents in the form of a markup language. The content providers 208, 221 can also include a database, scripts and/or markup language documents or pages. The scripts can include images, audio, grammars, computer programs, etc. The content providers 208, 221 execute suitable server software to send requested information to the voice browser 250.

The voice mail unit 274 is preferably connected to the telephone switch 203 and the LAN 240. The voice mail unit 274 can store voice mail messages from parties trying to send messages to the communication node 212. When a user accesses the electronic network 206, the voice mail unit 274 can notify the user of new and stored messages. The user can access the messages to play, delete, store and forward the messages. When the user accesses a message, the message can be read to the user or can be displayed as textual information on a communication device (e.g., a pager, a SMS 290, or a PDA, etc.). The user can also access and operate external messages or mail systems remote from the electronic network 206.

The FAX server unit 272 is preferably connected to the telephone switch 230 and the LAN 240. The FAX server unit 272 receivers and stores facsimile information sent via the electronic network 206 or the carrier network 216. Users can access the facsimile information to play, store, delete, and forward the information. The facsimile information can be read via the TTS unit 252 or can be displayed as textual information on a suitable communication device. The FAX server unit 272 preferably comprises a PC, such as, for example, a Windows NT compatible PC or a Dialogue Fax Server.

Further information regarding communication system 200 is disclosed in U.S. patent application Ser. No. 09/141,485, entitled Telecommunication System and Methods Therefor, filed Aug. 27, 1998, the entire disclosure of which is incorporated herein.

It should be appreciated that the embodiments described above are to be considered in all respects only illustrative and not restrictive. The scope of the invention is indicated by the following claims rather than by the foregoing description. All changes that come within the meaning and range of equivalents are to be embraced within their scope.

I claim:

1. A method for selecting and executing an action in a communication node, the communication node in communication with at least a schedule database and a rules database, comprising:
receiving an incoming communication directed to a subscriber;
determining a communication priority of the incoming communication;
determining a status of the subscriber;
accessing the rules database, the rules database having a rule set of the subscriber;
selecting an action based on the rule set of the subscriber using the communication priority and the subscriber status; and
executing the action.

2. The method of claim 1 wherein the rule set is a predetermined rule set.

3. The method of claim 1 wherein the communication priority of the incoming communication is based on at least one of a caller identity, a device identity, a network identity, a location identity and a priority value.

4. The method of claim 1 wherein the subscriber status includes location information.

5. The method of claim 1 wherein the subscriber status includes presence information.

6. The method of claim 5 wherein the presence information is provided by a presence engine.

7. The method of claim 4 wherein the location information is determined from the schedule database.

8. The method of claim 4 wherein the location information is provided by a location determining system.

9. The method of claim 4 wherein the incoming communication occurs at a time, the time being used to determine the subscriber status of the subscriber.

10. The method of claim 1 wherein the subscriber status includes priority information from at least one of the schedule database, a location engine, a presence engine and the subscriber.

11. The method of claim 1 wherein the selection of the action is based on a comparison of the communication priority and the subscriber status.

12. The method of claim 1 wherein the action includes at least one of playing back a message of the subscriber, recording a message of the caller, providing a pager number of the subscriber to the caller, executing a page to the subscriber, executing a wire-line connection to the subscriber, executing a wireless connection to the subscriber, and providing subscriber status, location and contact information to the caller.

13. The method of claim 12 further comprising:
receiving subscriber dynamic feedback in response to the action; and
executing a subsequent action based on the rule set responsive to the dynamic feedback.

14. A system for selecting and executing an action in a communication node comprising:
computer readable program code to receive an incoming communication directed to a subscriber;
computer readable program code to determine a communication priority of the incoming communication;
computer readable program code to determine a status of the subscriber;
computer readable program code to access a rules database, the rules database having a rule set of the subscriber;
computer readable program code to select an action based on the rule set using the communication priority and the subscriber status; and
computer readable program code to execute the action.

15. The system of claim 14 comprising computer readable program code to determine at least one of a caller identity, a device identity, a network identity, a location identity and an input priority value of the incoming communication.

16. The system of claim 14 comprising computer readable program code to determine the subscriber status using at least location information.

17. The system of claim 16 comprising computer readable program code to determine a time of the incoming communication, the time being included in determining the subscriber status.

18. The system of claim 14 comprising computer readable program code to determine subscriber priority information from at least one of the schedule database, the location engine, the presence engine and the subscriber.

19. The system of claim 14 comprising computer readable program code to compare the communication priority and the subscriber status to select the action.

20. The system of claim 14 comprising:
computer readable program code to execute an action, the action including at least one of recording a message of the caller, providing a pager number of the subscriber to the caller, executing a page to the subscriber, executing a wire-line connection to the subscriber, executing a wireless connection to the subscriber and providing location and contact information to the caller.

21. A system for selecting and executing an action in a communication node, the node including a voice mail server comprising:
a first communication device associated with a caller;
a second communication device associated with a subscriber;
a communication network in communication with the first and second communication device and the node;
a schedule database in communication with the node;
a rules database in communication with the node; and
wherein the node is adapted to select and execute an action based on information from the schedule database and the rules database, the action being executed by the voice mail server.

22. A system for selecting and executing an action in a communication node, the node including a communication device determining server:
a first communication device associated with a caller;
a second communication device associated with a subscriber;
a communication network in communication with the first and second communication device and the node;
a schedule database in communication with the node;
a rules database in communication with the node; and
wherein the node is adapted to select and execute an action based on information from the schedule database and the rules database, the action being executed by the communication device determining server.

23. The system of claim 22 wherein the node is adapted to receive subscriber dynamic feedback and execute a subsequent action based on the rule set responsive to the dynamic feedback.
